(19) United States
(12) Patent Application Publication
(10) Pub. No.: US 2003/0126085 A1
(43) Pub. Date: Jul. 3, 2003

(54) Dynamic authentication of electronic messages using a reference to a certificate

(75) Inventor: Andre Srinivasan, San Francisco, CA (US)

Correspondence Address: Mr. Rajiv Maheshwari, Slam Dunk Networks, Inc., 100 Redwood Shores Parkway, Suite 100, Redwood City, CA, 94065, US

(73) Assignee: SlamDunk Networks, Inc., Redwood City, CA

(21) Appl. No.: 10/033,700

(22) Filed: Dec. 27, 2001

(51) Int. Cl. G06F 17/60

(52) U.S. Cl. 705/51

(57) ABSTRACT

Systems and methods for dynamic authentication of a digital signature included in an electronic message are provided. The sender sends a certificate reference together with a digitally signed electronic message. The certificate reference uniquely maps to a certificate stored in a public key infrastructure (PKI). Upon receipt of the message, including the certificate reference, the recipient requests the certificate from the PKI by sending the certificate reference to the PKI. The PKI responds by mapping the certificate reference to the corresponding certificate and providing the certificate, which may then be used to authenticate the digital signature.

### BACKGROUND OF THE INVENTION

The invention relates in general to secure electronic communication and in particular to authentication of an electronic message.

Many businesses rely on electronic communication networks to speed transaction processing in situations such as order placement, electronic funds transfer, and credit card purchases. The dangers of impersonation and message tampering in such systems are well known. For instance, one user may attempt to impersonate another by sending bogus messages purporting to originate from the impersonated user, or a user may intercept a message sent by another user and alter the data therein, so that the recipient receives an inaccurate message. To prevent impersonation or message tampering, secure communication networks provide authentication capability, whereby a recipient is able to verify that a message actually originated with the purported sender; this capability often includes the ability to confirm that the content of the message has not been altered.

For example, digital signatures based on public key encryption technology may be used to provide message authentication and integrity. In public key authentication, each message sender (A) has a public key (Apub) and a private key (Apriv), typically two large numbers (e.g., 1024 or 2048 bits) related such that data encrypted with the public key according to a certain algorithm can only be decrypted using the private key and vice versa. Sender A makes its public key accessible to other users while keeping its private key a secret. To sign a message, sender A encrypts a cryptographic digest of the message using its private key Apriv. This encrypted message digest is referred to as a digital signature. Assuming that a recipient (B) of the message has the sender's public key Apub, the recipient can apply public key Apub to decrypt the message digest. Then, by comparing the decrypted digest to a computed digest of the received message, the recipient can authenticate the message—i.e., verify that the message originated with sender A and that the message was not altered after sender A sent it.

One difficulty of public key authentication is providing a means by which the recipient B can be confident that he has sender A's true public key. For instance, a third user (Z) who wished to impersonate sender A could generate a public-private key pair (Zpub, Zpriv). Then, purporting to be sender A, user Z could send the public key Zpub to recipient B in a first message with a claim that Zpub was sender A's public key. Then user Z could digitally sign a second message to recipient B using the private key Zpriv. If recipient B believed that the first message was from sender A, recipient B would falsely infer that the second message was genuine.

A partial solution to this difficulty is a “certificate authority” (CA), i.e., a trusted third party that certifies that a particular public key does belong to a particular user. After performing specified checks to verify the identity of a user (e.g., sender A), the CA prepares a “certificate” for the user, generally in the form of an electronic document containing information about the subject party (the user) and the issuing party (the CA). An example of a certificate 110 issued to sender A by a CA (X) is shown in FIG. 1. Certificate 110 contains the identity of the subject (A), the subject's public key (Apub), the name of the authority (X) that issued the certificate, as well as a serial number (123) and expiration date (Dec. 31, 2009) assigned by the authority. Certificate 110 is digitally signed by authority X using X's private key. A recipient of certificate 110 with access to X's public key is thus able to verify that certificate 110 originated with X and has not been tampered with.

To authenticate X's identity, certificate 110 may be associated with one or more other certificates such as certificates 130, 150 in a certificate chain 100. Certificate 130 is issued by another, often related, authority (Y) to verify the identity of authority X. Certificate 130 is similar to certificate 110, except that X is the subject and Y is the issuing authority. Certificate 150, in turn, verifies the identity of authority Y. Unlike certificates 110 and 130, certificate 150 is “self-signed,” that is, Y is both the subject and the issuing authority. At this point, the certificate chain 100 ends, and a recipient of certificates 110, 130, 150 must decide whether to trust authority Y. Trust of authority Y is generally established through an out-of-band technique; for instance, entity Y may ship a floppy disk containing certificate 150 to the recipient. If trust is established, then the recipient uses public key Ypub from certificate 150 to authenticate certificate 130, public key Xpub from certificate 130 to authenticate certificate 110, and public key Apub from certificate 110 to authenticate a message purportedly sent by sender A.

In general, however, a CA does not provide sender A's certificate(s) to other users (e.g., recipient B). Instead, sender A has to provide the certificate(s) directly to recipient B, either with a message or in advance of sending any messages. Sending the certificates with a message adds overhead to the message size. For instance, a typical certificate includes about 1 kilobyte of data, and certificate chains often include three or four certificates. Thus, if a typical certificate chain is sent with a message, an overhead of 3-4 kilobytes is added to each message. If the message itself contains only a few hundred bytes of data (e.g., a typical credit card transaction), the overhead added by the certificates may significantly slow transmission of the message.

Alternatively, sender A may provide its certificates to future message recipients in advance of sending any messages, so that each recipient can store the certificates in a local keystore. However, this method also has drawbacks. For instance, sender A must have advance knowledge of which recipient(s) will be receiving future messages; otherwise, communication of at least the first message to a particular recipient will be delayed while sender A transmits 3-4 kilobytes of certificate data. In addition, sender A and each future message recipient must agree on a way to reference the certificate in the recipient's keystore; otherwise, sender A will still need to provide certificates with each message. Moreover, a particular recipient's local keystore may be destroyed or damaged without sender A's knowledge, in which case there would be a delay in communication while the recipient requested and received sender A's certificates.

Public key infrastructures (PKIs) have been devised for storing and validating certificates. Generally, a message recipient who already has obtained the sender's certificate may query a PKI to confirm the validity of the certificate, but this does not obviate the need for the sender to provide certificates to the recipient, either with the message or in advance. A PKI may also provide a directory of stored certificates. Such directories are typically searchable by subject name, so that a message recipient could search for a certificate using the sender's name as a subject name. But because a subject name is generally not guaranteed to be unique, the search may return several certificates, in which case the recipient must determine whether one of them is the desired certificate.

Hence, it would be desirable to provide a PKI in which each certificate is uniquely mapped to a certificate identifier.

### BRIEF SUMMARY OF THE INVENTION

The present invention provides dynamic authentication of a digital signature included in an electronic message. The sender sends a certificate reference together with a digitally signed electronic message. The certificate reference uniquely maps to a certificate stored in a public key infrastructure (PKI). Upon receipt of a message that includes a certificate reference, the recipient requests a certificate from the PKI by sending the certificate reference to the PKI. The PKI responds by mapping the certificate reference to the corresponding certificate and providing the certificate, which may then be used to authenticate the digital signature. In some embodiments, multiple certificate references may be included with the electronic message; in other embodiments, the PKI may map a certificate reference to a certificate chain and provide the entire chain in response to a received certificate reference.

According to one aspect of the invention, in a public key authentication system, a method of sending an authenticated message to a recipient via a network is provided. A message is digitally signed using a first private key associated with the sender. A first certificate reference associated with a first certificate is retrieved, the first certificate including a first public key corresponding to the first private key; wherein the first certificate and the associated first certificate reference are stored in a public key infrastructure. An authenticated message comprising the digitally signed message and the first certificate reference is transmitted to the recipient via the network. The first certificate may be transmitted to the public key infrastructure prior to transmitting the authenticated message. The first certificate reference may be determined from an identity of the sender and a serial number of the first certificate.

According to another aspect of the invention, a second certificate reference to a second certificate may also be provided, wherein the second certificate is issued to an issuer of the first certificate and wherein the second certificate and the associated second certificate reference are stored in the public key infrastructure. The second certificate reference may be transmitted as a further part of the authenticated message.

According to still another aspect of the invention, the message may be encrypted using a second public key, wherein the recipient holds a second private key corresponding to the second public key.

According to a further aspect of the invention, in a public key authentication system, a method for authenticating a message received from a sender is provided. The received message includes a digitally signed message and a first certificate reference. The first certificate reference is transmitted to a public key infrastructure via a network. A first certificate corresponding to the first certificate reference is received from the public key infrastructure via the network, the first certificate including a first public key. It is then determined whether the first certificate is trusted; if the first certificate is trusted, the digitally signed message is authenticated using the first public key. The first certificate reference and the first public key may be stored in a recipient's local keystore.

Determining whether the first certificate is trusted may comprise identifying a first issuer of the first certificate; comparing the first issuer to each of at least one trusted issuer; and if the first issuer is the same as one of the at least one trusted issuer, determining that the first certificate is trusted.

According to a still further aspect of the invention, when the received message further includes a second certificate reference, the method may further comprise transmitting the second certificate reference to the public key infrastructure via the network; and receiving from the public key infrastructure a second certificate corresponding to the second certificate reference, the second certificate including a second public key associated with an issuer of the first certificate. Determining whether the first certificate is trusted may comprise determining whether the second certificate is trusted; if the second certificate is trusted, using the second public key to authenticate an issuer signature included in the first certificate, thereby verifying the first certificate; and if the first certificate is verified, determining that the first certificate is trusted.

According to another aspect of the invention, a method is provided for obtaining a public key for authenticating a received message comprising a digitally signed message and a certificate reference. First, it is determined whether the certificate reference is stored within a local keystore. If the certificate reference is stored within the local keystore, a public key associated with the certificate reference is retrieved from the local keystore. If the certificate reference is not stored within the local keystore, the certificate reference is transmitted to a public key infrastructure, and a certificate is received from the public key infrastructure. The certificate corresponds to the certificate reference and includes the first public key. A determination is made whether to trust the certificate; and information is added to the local keystore, the information including at least the certificate reference and the public key. The digitally signed message may then be authenticated using the public key.

According to still another aspect of the invention, a method of operating a public key infrastructure comprises receiving a certificate from a first user; computing a unique certificate reference from data contained in the certificate; storing the certificate in association with the unique certificate reference; receiving a request from a second user, the request including the unique certificate reference; and transmitting the certificate to the second user in response to the request. The data used to compute the unique certificate reference may comprise a subject entity and a serial number contained in the certificate.

According to a further aspect of the invention, a method of authenticating a message in a public key authentication system comprising a sender, a recipient, a public key infrastructure and a network comprises, at the sender side, digitally signing a message using a first private key belonging to the sender; retrieving a first certificate reference associated with a first certificate, the first certificate including a first public key corresponding to the first private key, wherein the first certificate and the associated first certificate reference are stored in the public key infrastructure; and transmitting a message comprising the digitally signed message and the first certificate reference to the recipient via the network; and, at the recipient side, receiving the message; transmitting the first certificate reference to the public key infrastructure via the network; receiving the first certificate from the public key infrastructure via the network; and authenticating the digitally signed message using the first public key.

According to a still further aspect of the invention. a public key infrastructure comprises a data store containing at least one certificate, wherein each of the at least one certificate is associated with a different one of at least one certificate reference; and a server coupled to the data store, wherein the server is configured to receive a certificate, to compute a certificate reference for the received certificate from data included in the certificate, and to store the received certificate in association with the computed certificate reference in the data store, and wherein the server is further configured to respond to a request for a certificate, the request including a received certificate reference, by identifying and providing the one of the at least one stored certificate associated with the received certificate reference.

According to yet another aspect of the invention, an electronic communication system comprises a public key infrastructure configured to store a plurality of certificates, to associate with each of the plurality of certificates a different one of a plurality of certificate references, and in response to a request including one of the plurality of certificate references, to return the corresponding one of the plurality of certificates; a sender configured to digitally sign a message using a first private key and to send a message including the digitally signed message and a first certificate reference; and a recipient configured to receive the message, to send a request including the first certificate reference to the public key infrastructure, to receive a corresponding first certificate from the public key infrastructure, and to use the first certificate to authenticate the digitally signed message.

The following detailed description together with the accompanying drawings will provide a better understanding of the nature and advantages of the present invention.

### BRIEF DESCRIPTION OF THE DRAWINGS

FIG. 1 is a simplified schematic illustration of a prior art certificate chain;

FIG. 2 is a simplified block diagram of a system for electronic communication according to an exemplary embodiment of the present invention;

FIGS. 3A-B are simplified schematic illustrations of alternative exemplary embodiments of a certificate database according to the present invention;

FIG. 4 is a flow chart of an exemplary process for sending a message according to the present invention;

FIG. 5 is a flow chart of an exemplary process for handling a received message according to the present invention; and

FIG. 6 is a flow chart of an alternative exemplary process for handling a received message according to the present invention.

### DETAILED DESCRIPTION OF THE INVENTION

The present invention provides a method for authenticating a digital signature included in an electronic message. The sender sends a certificate reference together with a digitally signed electronic message. The certificate reference uniquely maps to a certificate stored in a public key infrastructure (PKI). Upon receipt of the message, including the certificate reference, the recipient requests the certificate from the PKI by sending the certificate reference to the PKI. The PKI responds by mapping the certificate reference to the corresponding certificate and providing the certificate to the recipient. The recipient may then use the certificate to authenticate the digital signature. Thus, message authentication is made possible without requiring either party to have advance knowledge that a message will be sent or to send certificates with messages. Further, because a reference is smaller than the certificate referenced, the speed of communication may be increased.

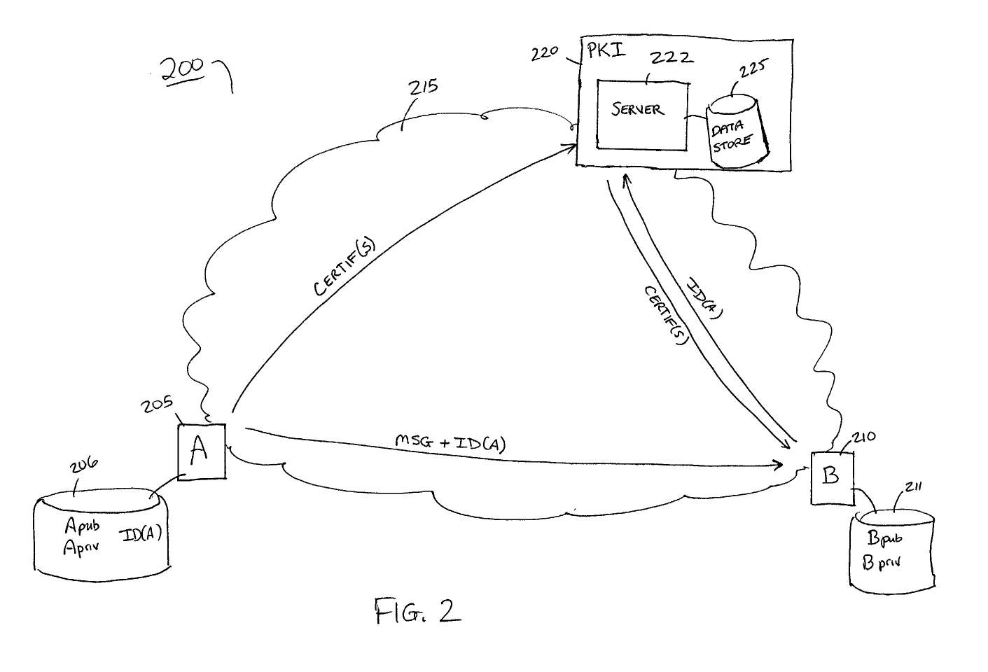

FIG. 2 illustrates an exemplary embodiment of a system 200 according to the present invention. Message sender (A) 205 and message recipient (B) 210 communicate via a network 215. Network 215 may be any network enabling electronic communication among multiple computer systems, for example, the global communication system known as the Internet. Sender 205 and recipient 210 may be human users or components on the network, such as servers or clients or other components, depending on the implementation. Sender 205 and recipient 210 each employ public key encryption. Sender 205 has a local data store 206 containing the sender's encryption key pair: a private key (Apriv) and a public key (Apub). Recipient 210 has a local data store 211 containing the recipient's encryption key pair: a private key (Bpriv) and a public key (Bpub). Recipient 210 does not need to have advance knowledge that sender 205 intends to communicate with recipient 210 or even that sender 205 is connected to network 215. Likewise, sender 205 is not required to have advance knowledge of or prior communication with recipient 210.

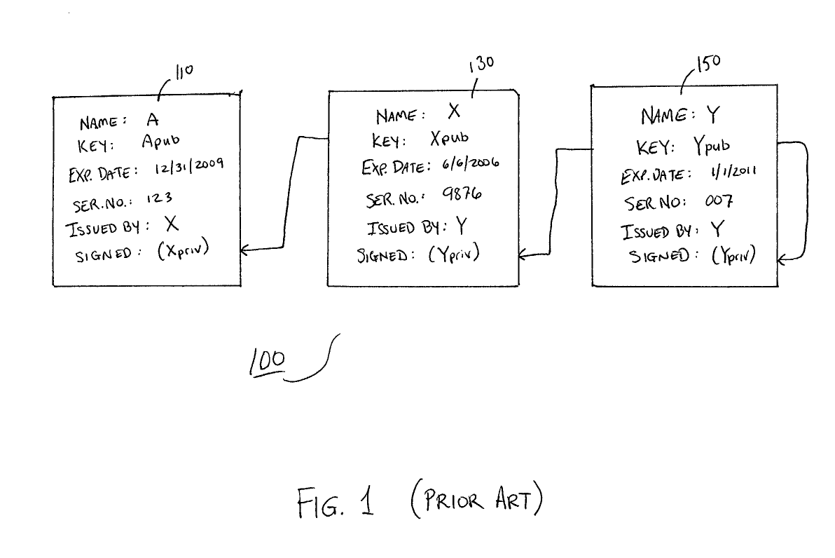

Also communicating with sender 205 and recipient 210 via network 215 is a public key infrastructure (PKI) 220. PKI 220 includes a server 222 and a data store 225. Data store 225 includes certificates issued to various entities connected to network 215, such as sender 205 and recipient 210. In general, a certificate includes at least a public key associated with the subject entity of the certificate. Other data may be stored; for instance, the certificates may be similar to certificates 110, 130, 150 of FIG. 1.

PKI 220 is configured to accept certificates from users and/or components connected to network 215, including sender 205 and recipient 210. Upon receipt of a certificate (e.g., certificate 110 of FIG. 1), PKI server 222 is configured to compute a unique identifier (ID(Acert)) corresponding to the certificate. For instance, PKI server 222 may generate the unique identifier from the serial number of the certificate and the name of the subject entity. In one preferred embodiment, the unique identifier consists of approximately 30 bytes of data. It will be appreciated that other algorithms using other data may also be employed to generate unique identifiers. PKI server 222 then stores the certificate together with the computed unique identifier in data store 225, so that the unique identifier may later be used to retrieve the certificate. In some embodiments where each user or component on the network has a unique name, certificates stored in data store 225 may also be accessible by the name of the subject entity.

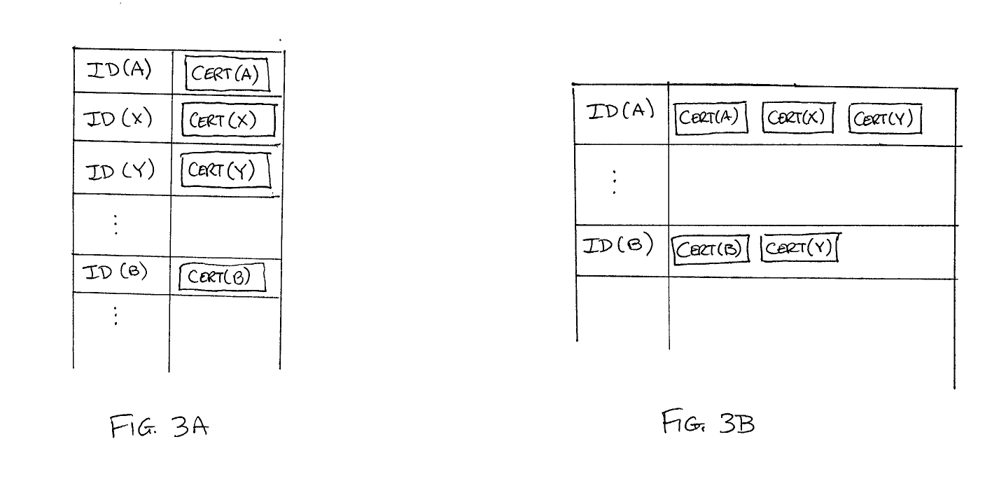

FIG. 3A illustrates one exemplary embodiment of a certificate table in data store 225. In this embodiment, a unique identifier in the first column is associated with a certificate in the second column. Because a unique identifier may be computed for any certificate, each certificate 110, 130, 150 in a certificate chain 100 may be stored in data store 225. FIG. 3B illustrates an alternative embodiment of a certificate table in which a certificate chain is associated with a single unique identifier. For instance, the identifier ID(Acert) is associated with certificates 110, 130, 150. It will be appreciated that data store 225 may be implemented using any suitable data management and storage technology.

The algorithm used by PKI server 222 to compute a unique identifier is preferably known to users including sender 205. In one such embodiment, sender 205 also computes the unique identifier by using the same algorithm instead of receiving the computed unique identifier from PKI server 222. Alternatively, PKI server 222 may be configured to send the unique identifier to sender 205, for instance, as part of an acknowledgment that the certificate was received. In either case, sender 205 preferably stores the unique identifier for each of its certificates in local data store 206.

PKI server 222 is also configured to receive a request including a unique identifier from users including recipient 210 and to respond by mapping the unique identifier to the corresponding certificate and transmitting the corresponding certificate to the requesting user. In embodiments where chains of certificates are stored in data store 225 (e.g., FIG. 3B), PKI server 222 may be configured to transmit one certificate per identifier or to transmit the entire chain in response to a request including a unique identifier for only the first certificate in a chain.

It will be appreciated that the description of system 200 herein is illustrative, and that components may be varied or modified. For instance, PKI 220 may be implemented using more or fewer components than described herein. PKI 220 may include multiple processors, and the various functionality of PKI 220 may be distributed among the processors in any suitable manner.

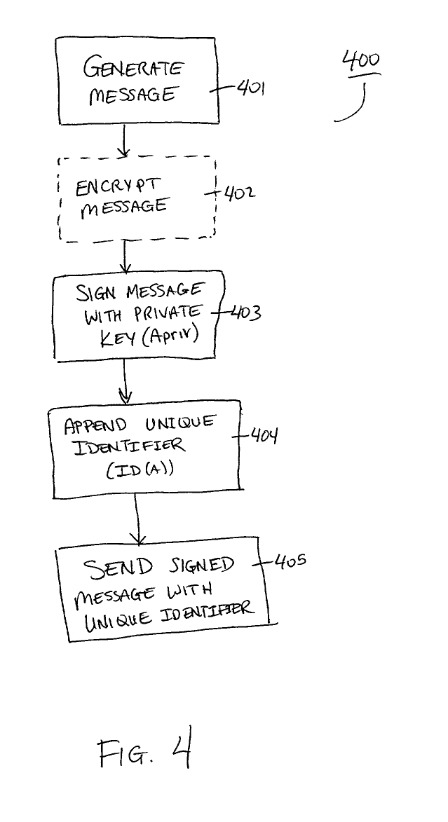

FIG. 4 illustrates an exemplary process 400 for sending a message using a system such as system 200. At step 401, the sender 205 generates a message to be sent to recipient 210. In some embodiments, message data may be provided to sender 205, in which case generation of a message is not performed. Optionally, at step 402, the sender encrypts the message. For example, a public key encryption algorithm using the recipient's public key may be employed. The sender may obtain the recipient's public key by requesting the recipient's certificate from PKI 220. Depending on implementation, the request may be made using the unique identifier associated with the certificate (if known) or the recipient's name (if unique component names are implemented). Alternatively, the sender may query the recipient directly to obtain the recipient's public key. Other encryption technology may also be employed at step 402 to encrypt the message for secrecy.

At step 403, the sender digitally signs the message using the sender's private key (Apriv). In a preferred embodiment, signing involves producing a message digest according to an algorithm known to both sender and recipient (e.g., a one-way hash) and encrypting only the digest using the sender's private key.

At step 404, the sender appends to the message one or more unique identifiers (e.g., ID(Acert)) associated with the sender's certificate(s) that were previously stored in PKI data store 225. Where certificate chains (e.g., chain 100) are implemented, the sender may provide an identifier (e.g., ID(Acert), ID(Xcert), ID(Ycert)) for each of its certificates. Alternatively, in embodiments such as that of FIG. 3B, the sender may provide a reference only to the first certificate in the chain (e.g., ID(Acert)). At step 405, the sender sends the message including the unique identifier(s).

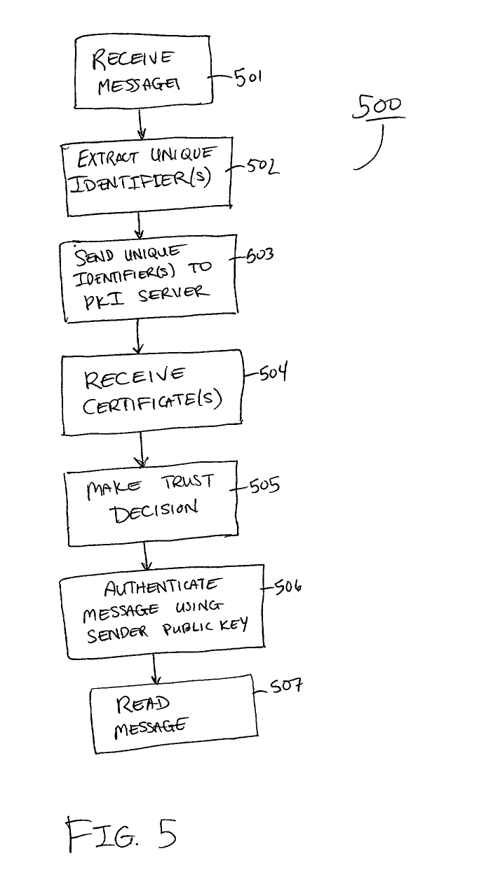

FIG. 5 illustrates an exemplary process 500 for receiving and authenticating a message using a system such as system 200. At step 501, the recipient 210 receives a message that has been sent by sender 205 using a process such as process 400, the message including one or more unique identifiers corresponding to the sender's certificate(s) in PKI data store 225. At step 502, the recipient extracts the identifier(s) (e.g., ID(Acert)) and, at step 503, sends it (them) to PKI 220. At step 504, the recipient receives a response from the PKI that includes the certificate(s) (e.g., certificate 110) corresponding to each identifier. In some embodiments where the sender provides multiple identifiers to the recipient, steps 503 and 504 may be repeated, or the recipient may send all received identifiers to the PKI in a single request. Additionally, in embodiments where a certificate chain is associated with a single unique identifier in the PKI data store (e.g., FIG. 3B), the PKI may send the entire certificate chain in response to a request that includes the single identifier.

At step 505, the recipient makes a trust decision using the received certificate(s). For instance, if recipient 210 receives certificates 110, 130, 150 from PKI 220, then recipient 210 may use X's public key contained in certificate 130 to verify certificate 110, then use Y's -public key contained in certificate 150 to verify certificate 130 as well as (self-signed) certificate 150. If all of the verifications succeed and if recipient 210 trusts entity Y (which may be determined using techniques known in the art), then recipient 210 trusts that certificate 110 contains A's public key. If a verification fails or if recipient 210 does not trust entity Y, then recipient 210 may elect not to trust that certificate 110 contains A's public key. In making the trust decision, recipient 210 may also consider other information, e.g., whether any of the certificates has expired. If the trust decision is favorable, then at step 506, recipient 210 uses A's public key contained in certificate 110 to authenticate the message.

At step 507, if the message is authenticated, the recipient proceeds to read the message. If the sender encrypted the message using the recipient's public key or other encryption technology, step 507 generally includes decrypting the message using appropriate decryption technology.

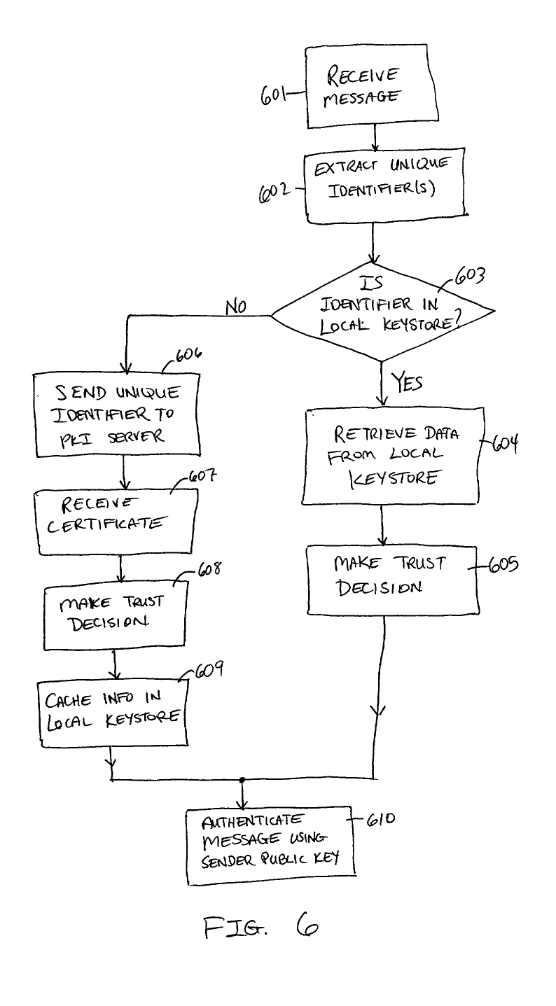

In some embodiments, a recipient may build up a local keystore as messages are received from various senders 205. FIG. 6 illustrates an exemplary process 600 for receiving a message in an embodiment in which a recipient has a local keystore. At step 601, the recipient receives a message including one or more unique identifiers (e.g., ID(Acert)). At step 602, the recipient extracts the unique identifier(s), then at step 603 looks for each identifier in the recipient's local keystore. If a match is found, then at step 604, information from the local keystore corresponding to the identifier is retrieved. This information includes the sender's public key, and may also include one or more of the sender's certificates (e.g., certificates 110, 130, 150). In some implementations, the local keystore may also include an outcome of a previous trust decision regarding the sender or other information.

At step 605, the retrieved information is used to make a trust decision. In some embodiments, the recipient may treat all keys in the local keystore as verified. Alternatively, the trust decision may involve additional steps, for instance, checking the expiration date of the certificate(s) associated with the identifier and making sure that the issuing authority of each certificate is still trusted. If the recipient decides to trust the certificates, then at step 610, the recipient authenticates and reads the message.

If no match is found at step 603, then at step 606, the recipient queries the PKI using the received identifier(s) (e.g., ID(Acert)). The recipient receives the corresponding certificate(s) from the PKI (step 607) and makes a trust decision (step 608). These steps may be implemented as described above with reference to FIG. 5. At step 609, some or all of the information obtained from the PKI, including the sender's public key, is cached in the recipient's local keystore. The result of the trust decision may also be cached. The information cached is associated with the identifier (e.g., ID(A)). In some embodiments, if the trust decision at step 608 is unfavorable, no information is cached, or information that the received identifier is unverified is cached. At step 610, if the recipient has decided to trust the sender, the recipient authenticates and reads the message.

The information cached at step 609 remains in the recipient's local keystore and is available for processing of subsequently received message. Thus, upon receipt of a first message including a particular unique identifier, the recipient queries the PKI and obtains certificates, enabling a sender to send a message to a recipient who has no advance knowledge of the sender's public key or even of the sender's presence on the network. If the keystore is maintained, the recipient may process a subsequent message from the same sender without querying the PKI if the subsequent message contains the same unique identifier as the first message. In addition, the trust decision for subsequent messages may require fewer computations; for instance, in some implementations it is not necessary to repeat the authentication of the certificates in a certificate chain. Thus, communication with message authentication is made more efficient.

It will be appreciated that the processes described herein are illustrative. Process steps may be varied or modified, and systems other than system 200 may be used to implement any of the processes.

Although the invention has been described with reference to specific embodiments, it will be appreciated that variations and modifications are possible. For instance, a sender may also receive messages, in which case the sender may perform the recipient functions. In addition, systems such as system 200 may be implemented as “closed” systems in which the sender, the recipient, and the PKI are subject to common control, for instance, for purposes of assigning component names. Alternatively, the system may be implemented as an “open” system, in which the sender, the recipient, and the PKI are not subject to common control; all that is required is that each of sender and recipient trusts data received from the PKI and that each uses a compatible communication protocol. Further, the communication network need not be the Internet; local area networks, virtual private networks, or any other network may be substituted. Moreover, persons of ordinary skill in the art will recognize that the invention may be implemented using any combination of hardware and/or software components.

Therefore, it will be appreciated that the scope of the invention is not limited by the foregoing description but by the scope of the following claims, including equivalents.

What is claimed is:

1. In a public key authentication system, a method of sending an authenticated message to a recipient via a network, the method comprising:
digitally signing a message using a first private key associated with the sender;
retrieving a first certificate reference associated with a first certificate, the first certificate including a first public key corresponding to the first private key, wherein the first certificate and the associated first certificate reference are stored in a public key infrastructure; and
transmitting to the recipient via the network an authenticated message comprising the digitally signed message and the first certificate reference.

2. The method of claim 1, further comprising:
transmitting the first certificate via the network to the public key infrastructure prior to transmitting the authenticated message.

3. The method of claim 1, wherein the first certificate reference is determined from an identity of the sender and a serial number of the first certificate.

4. The method of claim 1 further comprising:
retrieving a second certificate reference to a second certificate, wherein the second certificate is issued to an issuer of the first certificate, wherein the second certificate and the associated second certificate reference are stored in the public key infrastructure; and
transmitting the second certificate reference as a further portion of the authenticated message.

5. The method of claim 1, wherein the network is the Internet.

6. The method of claim 1, further comprising encrypting the message using a second public key, wherein the recipient holds a second private key corresponding to the second public key.

7. In a public key authentication system, a method for authenticating a message received from a sender via a network, the received message including a digitally signed message and a first certificate reference, the method comprising:
transmitting the first certificate reference to a public key infrastructure via the network;
receiving from the public key infrastructure via the network a first certificate corresponding to the first certificate reference, the first certificate including a first public key;
determining whether the first certificate is trusted; and
if the first certificate is trusted, authenticating the digitally signed message using the first public key.

8. The method of claim 7, further comprising:
storing in a local keystore the first certificate reference and the first public key.

9. The method of claim 7, wherein the step of determining whether the first certificate is trusted comprises:
identifying a first issuer of the first certificate;
comparing the first issuer to each of at least one trusted issuer; and
if the first issuer is the same as one of the at least one trusted issuer, determining that the first certificate is trusted.

10. The method of claim 7, wherein the received message further includes a second certificate reference, the method further comprising:
transmitting the second certificate reference to the public key infrastructure via the network; and
receiving from the public key infrastructure a second certificate corresponding to the second certificate reference, the second certificate including a second public key associated with an issuer of the first certificate.

11. The method of claim 10, wherein the step of determining whether the first certificate is trusted comprises:
determining whether the second certificate is trusted;
if the second certificate is trusted, using the second public key to authenticate an issuer signature included in the first certificate, thereby verifying the first certificate; and
if the first certificate is verified, determining that the first certificate is trusted.

12. The method of claim 7, wherein the network is the Internet.

13. In a public key authentication system, a method for obtaining a public key for authenticating a received message comprising a digitally signed message and a first certificate reference, the method comprising:
determining whether the first certificate reference is stored within a local keystore;
if the first certificate reference is stored within the local keystore:
retrieving from the local keystore a first public key associated with the first certificate reference; and
if the first certificate reference is not stored within the local keystore:
transmitting the first certificate reference to a public key infrastructure;
receiving from the public key infrastructure a first certificate corresponding to the first certificate reference, the first certificate including the first public key;
determining whether to trust the first certificate; and
adding information to the local keystore, the information including at least the first certificate reference and the first public key.

14. The method of claim 13, further comprising:
authenticating the digitally signed message using the first public key.

15. A method of operating a public key infrastructure, the method comprising:
receiving a certificate from a first user;
computing a unique certificate reference from data contained in the certificate;
storing the certificate in association with the unique certificate reference;
receiving a request from a second user, the request including the unique certificate reference; and
transmitting the certificate to the second user in response to the request.

16. The method of claim 15, wherein the data contained in the certificate includes a subject identity and a serial number, and wherein the unique certificate reference is computed from the subject identity and the serial number.

17. In a public key authentication system comprising a sender, a recipient, a public key infrastructure and a network, a method of authenticating a message sent by the sender to the recipient, the method comprising:
at the sender side:
digitally signing a message using a first private key belonging to the sender;
retrieving a first certificate reference associated with a first certificate, the first certificate including a first public key corresponding to the first private key, wherein the first certificate and the associated first certificate reference are stored in the public key infrastructure; and
transmitting a message comprising the digitally signed message and the first certificate reference to the recipient via the network; and
at the recipient side:
receiving the message;
transmitting the first certificate reference to the public key infrastructure via the network;
receiving the first certificate from the public key infrastructure via the network; and
authenticating the digitally signed message using the first public key.

18. A public key infrastructure comprising:
a data store containing at least one certificate, wherein each of the at least one certificate is associated with a different one of at least one certificate reference; and
a server coupled to the data store,
wherein the server is configured to receive a certificate, to compute a certificate reference for the received certificate from data included in the certificate, and to store the received certificate in association with the computed certificate reference in the data store, and
wherein the server is further configured to respond to a request for a certificate, the request including a received certificate reference, by identifying and providing the one of the at least one stored certificate associated with the received certificate reference.

19. An electronic communication system comprising:
a public key infrastructure configured to store a plurality of certificates, to associate with each of the plurality of certificates a different one of a plurality of certificate references, and in response to a request including one of the plurality of certificate references, to return the corresponding one of the plurality of certificates;
a sender configured to digitally sign a message using a first private key and to send a message including the digitally signed message and a first certificate reference; and
a recipient configured to receive the message, to send a request including the first certificate reference to the public key infrastructure, to receive a corresponding first certificate from the public key infrastructure, and to use the first certificate to authenticate the digitally signed message.
